(19) United States
(12) Patent Application Publication
(10) Pub. No.: US 2026/0097597 A1
(43) Pub. Date: Apr. 9, 2026

(54) RECORDING APPARATUS AND CONTROL METHOD THEREOF

(71) Applicant: CANON KABUSHIKI KAISHA, Tokyo (JP)

(72) Inventor: NAOTOSHI KUDO, Kanagawa (JP)

(21) Appl. No.: 19/346,833

(22) Filed: Oct. 1, 2025

(30) Foreign Application Priority Data
Oct. 3, 2024 (JP) 2024-174562

(51) Int. Cl. B41J 15/04; B41J 11/00; B41J 15/16

(52) U.S. Cl. CPC B41J 15/046; B41J 11/0095; B41J 15/042; B41J 15/048; B41J 15/16

(57) ABSTRACT

A recording apparatus includes a recording unit configured to record images on a continuous sheet, a conveyance unit configured to convey the sheet in a forward direction and in a reverse direction opposite to the forward direction, a correction unit configured to correct the skew of the sheet, and a control unit configured to control the correction unit and the conveyance unit when correcting the skew of the sheet conveyed in the forward direction. The control unit executes a first control to correct the skew of the sheet with a first conveyance amount as a conveyance amount of the sheet after a predetermined condition causing a skew of the sheet has occurred, and a second control to correct the skew of the sheet with a second conveyance amount, which is less than the first conveyance amount, when the predetermined condition has not occurred.

### BACKGROUND

### Field of the Technology

The present disclosure relates to a recording apparatus that records images on a continuous sheet and a control method thereof.

### Description of the Related Art

A technique described in Japanese Patent Application Publication No. 2016-198971 relates to an image recording apparatus that records images on a continuous sheet, in which skew-prevention pre-feed control is executed by conveying the sheet a certain distance before starting the printing process so that printing begins only after the skew is stabilized and stable conveyance has been achieved. Japanese Patent Application Publication No. 2016-198971 aims to efficiently eliminate skew of continuous paper by determining the conveyance amount of the skew-prevention pre-feed control according to the type and basis weight of the recording medium.

In an image recording apparatus that records images on a continuous sheet, there are conditions under which significant skew of the sheet may occur. For example, in a configuration in which a conveyance unit that conveys a sheet includes a pair of rollers forming a nip portion to hold the sheet, if the nip portion is opened for purposes such as jam processing or roll replacement, the sheet is no longer held, resulting in increased skew of the sheet. In addition, since there is a certain degree of positional tolerance in the axial direction when a roll is mounted in an unwinding unit that supplies the sheet to a recording unit and a take-up unit that winds the sheets after recording, the skew of the sheet tends to increase after the roll is replaced. Furthermore, in a recording apparatus equipped with a skew correction unit that corrects the skew of the sheet, if the skew correction unit is configured to perform correction only during forward conveyance (i.e., the conveyance direction during recording), the skew of the sheet becomes more significant during a rewinding operation.

### SUMMARY

The present disclosure aims to suppress the skew of the sheet in an image recording apparatus that records images on a continuous sheet.

The recording apparatus of the present disclosure includes the following: a recording unit configure to record images on a continuous sheet; a conveyance unit configured to convey the sheet in a forward direction, which is a conveyance direction during recording by the recording unit, and in a reverse direction opposite to the forward direction; a correction unit configured to correct a skew of the sheet; and a control unit configured to control the correction unit and the conveyance unit while correcting the skew of the sheet conveyed in the forward direction, wherein the control unit executes a first control and a second control, the first control being a control to correct the skew of the sheet with a first conveyance amount as a conveyance amount of the sheet after a predetermined condition causing a skew of the sheet has occurred, and the second control being a control to correct the skew of the sheet with a second conveyance amount, which is less than the first conveyance amount, when the predetermined condition has not occurred.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing a schematic configuration of a recording apparatus according to an embodiment.

FIG. 2 is a block diagram showing the functional configuration of a control unit in the recording apparatus.

FIG. 3A is a cross-sectional view showing the configuration of a skew correction unit.

FIG. 3B is a top view of the skew correction unit.

FIG. 3C is a diagram of the skew correction unit showing the state in which the roll of a paper feeding device has been replaced while sheet conveyance is stable as in the state of FIG. 3B, and the roll's mounting position after replacement has shifted toward the back side in the width direction (upper side in the figure) relative to FIG. 3B.

FIG. 3D is a diagram showing the skew correction unit where a holding frame has rotated to an angle at which the sheet is conveyed linearly from a paper feeding device to a take-up device, and the rotation of the holding frame has stabilized.

FIG. 4A is a diagram showing the state of the sheet when a main conveyance unit and a sub-conveyance unit are in a nip state.

FIG. 4B is a diagram showing the state of the sheet when the main conveyance unit and the sub-conveyance unit have changed from a nip state to a nip release state.

FIG. 5 is a diagram showing a sheet feed operation unit of the recording apparatus.

FIG. 6 is a flowchart showing the process of setting a flag for skew correction control.

FIG. 7A is a diagram showing the relationship between the position of the widthwise edge portion of the sheet and the conveyance amount when a predetermined condition causing a significant skew of the sheet has occurred, in the context of the relationship between the conveyance amount and the widthwise position of the sheet in skew correction control.

FIG. 7B is a top view schematically showing a recorded image when a recording operation is performed in a state in which the sheet is not conveyed in the forward direction after the predetermined condition causing a significant skew of the sheet has occurred, in the context of the relationship between the conveyance amount and the widthwise position of the sheet in skew correction control.

FIG. 7C is a top view schematically showing a recorded image when a recording operation is performed in a state in which the sheet is not conveyed in the forward direction when the predetermined condition causing a significant skew of the sheet has not occurred, in the context of the relationship between the conveyance amount and the widthwise position of the sheet in skew correction control.

FIG. 8 is a flowchart showing skew correction control.

FIG. 9A is a diagram showing the state in which the recording apparatus is stopped during the execution of skew correction control.

FIG. 9B is a diagram showing a state in which a sheet is conveyed by a first conveyance amount from the state shown in FIG. 9A and ejection can be performed in the recording apparatus during the execution of skew correction control.

FIG. 9C is a diagram showing a state in which the sheet is conveyed by the second conveyance amount from the state shown in FIG. 9A and the sheet can be ejected in the recording apparatus during the execution of skew correction control.

### DESCRIPTION OF THE EMBODIMENTS

Modes for carrying out the present disclosure will now be described in detail below by way of illustration on the basis of embodiments in conjunction with the accompanying drawings. However, the dimensions, materials, shapes, relative arrangement, and the like of the components described in these embodiments should be appropriately changed depending on the configuration of the apparatus to which the disclosure is applied and various conditions. In other words, the scope of the present disclosure is not intended to be limited to the embodiments described below.

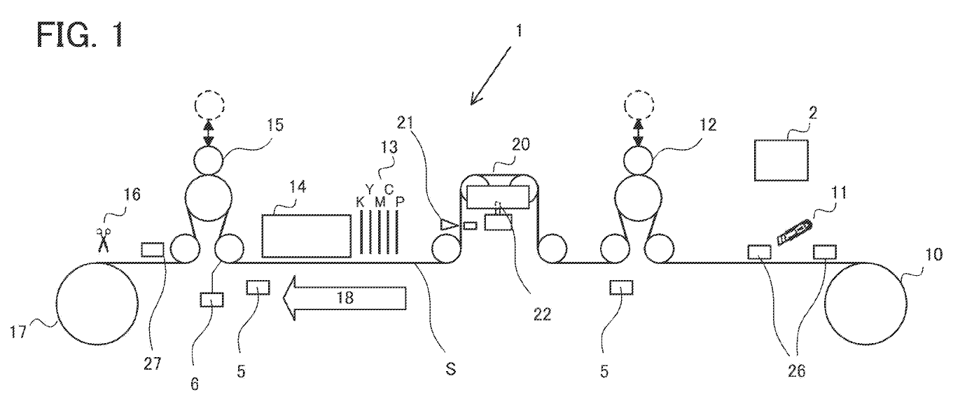

First Embodiment FIG. 1 is a diagram showing an internal configuration of a recording apparatus according to a first embodiment. FIG. 1 schematically shows a sheet conveyance path when the recording apparatus 1 is in a standby state. The recording apparatus 1 is a high-speed line printer that uses a continuous sheet S, wound into a roll at its end portion, as a recording medium. Hereinafter, the vertical direction in FIG. 1 is defined as the vertical direction of the recording apparatus 1, the left-right direction as the longitudinal direction of the recording apparatus 1, and the depth direction from the front to the back of the drawing as the width direction of the sheet. The conveyance direction of the sheet in the recording apparatus 1 is a direction intersecting the width direction of the sheet and is approximately orthogonal to the width direction. Also, in the following description, terms including "paper" like paper feeding, paper width, or rolled paper may be used, but the sheet S is not limited to paper, and may be a recording medium other than paper, such as a film.

FIG. 1 is a diagram schematically showing the conveyance path, and the actual conveyance path can have various configurations. For example, the sheet S is conveyed from right to left in the figure while recording is performed by a recording unit 13, then conveyed downward, and conveyed from left to right while drying and cooling are performed by a fixing unit 14. Subsequently, the sheet S is further conveyed downward and from right to left to be wound by a take-up device 17, forming an S-shaped path configuration. The configuration of the recording apparatus 1 may be any form as long as it can be schematically illustrated as shown in FIG. 1.

A paper feeding device 10 is provided at the most upstream side of the conveyance path of the sheet S in the recording apparatus 1. The paper feeding device 10 is an unwinding unit that supplies the sheet S to the recording unit 13 from a roll in which the sheet S is wound around a core. The roll attached to the paper feeding device 10 is, for example, a roll with 1000 meters of sheet S wound thereon.

At a position 1 meter downstream from the paper feeding device 10, a splicing unit 11 and a sheet pressing mechanism 26 are provided. The sheet pressing mechanism 26 is movable in a direction (vertical direction in the figure) orthogonal to the conveyance direction of the sheet S (left-right direction in the figure) and the width direction of the sheet S (depth direction in the figure), and is movable between a first position where it presses the sheet S and a second position where it is separated from the sheet S. The recording apparatus 1 includes a pressing mechanism operating unit (not shown) that allows a user to input instructions to operate the sheet pressing mechanism 26. The sheet pressing mechanism 26 is provided both upstream and downstream of the splicing unit 11.

A main conveyance unit 12 and a sub-conveyance unit 15 are conveyance units capable of performing a feeding operation to convey the sheet S in the forward direction, which is the conveyance direction during recording operations by the recording unit 13, and a rewinding operation to convey the sheet S in the reverse direction opposite to the forward direction. The main conveyance unit 12 is provided downstream of the splicing unit 11 and the sheet pressing mechanism 26. The sub-conveyance unit 15 is provided downstream of the recording unit 13 and the fixing unit 14. The main conveyance unit 12 and the sub-conveyance unit 15 each include a roller pair. The roller pair can be in a nip state, forming a nip portion that holds the sheet as shown by solid lines in FIG. 1, or in a nip release state, where one roller of the roller pair is separated from the other roller to release the nip portion, as shown by dashed lines in FIG. 1. When the roller pair is in the nip state, the feeding operation or the rewinding operation is performed by holding the sheet at the nip portion.

Although not shown in FIG. 1, a dancer roller for maintaining constant tension of the sheet S may be provided between the paper feeding device 10 and the main conveyance unit 12 or between the sub-conveyance unit 15 and the take-up device 17. The positions of the main conveyance unit 12 and the sub-conveyance unit 15 are not limited to those shown in FIG. 1. The means for conveying the sheet S may include only one of the main conveyance unit 12 or the sub-conveyance unit 15.

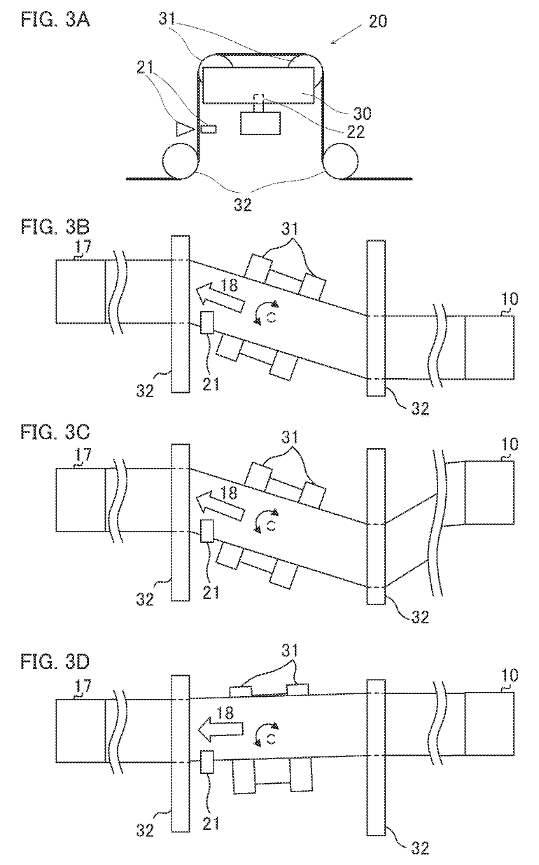

A skew correction unit 20 is provided between the main conveyance unit 12 and the recording unit 13. The skew correction unit 20 corrects skew before recording. The skew correction unit 20 is capable of performing a correction operation to correct the skew of the sheet conveyed in the forward direction. The skew correction unit 20 adjusts the widthwise position of the sheet during forward conveyance of the sheet to correct the skew of the sheet in the width direction. A sensor 21 is installed in a passing region of the widthwise edge portion of the sheet to detect the position of the widthwise edge portion of the sheet. When the position of the widthwise edge portion of the sheet deviates from a target position, the skew correction unit 20 rotates around a rotation shaft 22 to correct the skew of the sheet so that the position of the widthwise edge portion of the sheet aligns with the target position. Details will be described later with reference to FIGS. 3A to 3D.

The recording unit 13 includes a total of five heads, one each for primer, cyan, magenta, yellow, and black. Each head is a line head, and the position of the head is fixed, and recording is performed by ejecting ink from the head onto the sheet S while conveying the sheet S in the forward direction 18 relative to the recording unit 13. The forward direction 18 is the conveyance direction during recording operations by the recording unit 13.

A fixing unit 14 is provided downstream of the recording unit 13. The fixing unit 14 fixes the ink ejected onto the sheet by drying and cooling the ink. The fixing unit 14 includes a drier having a heater and a fan, and a cooler provided downstream of the drier and having a fan. The sheet heated by the drier and the ink ejected onto the sheet are cooled by the cooler.

A sub-conveyance unit 15 is provided downstream of the fixing unit 14.

The take-up device 17 is provided at the most downstream side of the sheet conveyance path of the recording apparatus 1. The take-up device 17 is a take-up unit that winds the sheet that has passed through the recording unit 13 onto a roll in which the sheet is wound around a core. The take-up device 17 is equipped with a sheet pressing mechanism 27 similar to the sheet pressing mechanism 26 of the paper feeding device 10.

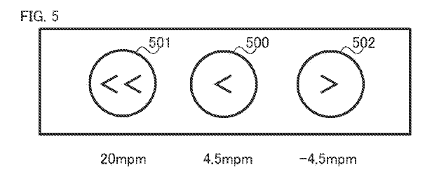

The recording apparatus 1 is equipped with a sheet feeding operating unit 5 that allows the user to operate the conveyance units (main conveyance unit 12 and sub-conveyance unit 15) to perform a feeding operation or a rewinding operation with an arbitrary conveyance amount. A plurality of sheet feeding operating units 5 are provided at various locations in the recording apparatus 1. The configuration of the sheet feeding operating unit 5 will be described later with reference to FIG. 5.

The recording apparatus 1 is equipped with a tension detector 6 that controls the tension applied to the sheet. The tension detector 6 is attached to both ends of a roller. The tension is detected by the sheet pulling the roller shaft. Since the tension detectors 6 are attached to both ends of the roller, the tension is taken as the average of these. A plurality of tension detectors 6 may be provided along the conveyance path of the recording apparatus 1.

The recording apparatus 1 is equipped with a control unit 2 that controls the operations of each component, including the paper feeding device 10, the take-up device 17, the main conveyance unit 12, the sub-conveyance unit 15, the recording unit 13, the fixing unit 14, the skew correction unit 20, the tension detector 6, and the sheet pressing mechanisms 26 and 27. When conveying the sheet in the recording apparatus 1, the control unit 2 controls the main conveyance unit 12 by varying the driving speed of the sub-conveyance unit 15, so that the tension detected by the tension detector 6 remains constant.

When replacing a roll in the paper feeding device 10, the user lowers the two sheet pressing mechanisms 26, located upstream and downstream of the splicing unit 11, by operating the pressing mechanism operating unit to press the sheet S. Thus, the movement of the sheet S is restricted. The user cuts the sheet S at the splicing unit 11 provided between the two sheet pressing mechanisms 26. Subsequently, the user raises only the sheet pressing mechanism 26 upstream of the splicing unit 11 (right side in the figure) to release the pressing of the sheet S and replaces the roll set in the paper feeding device 10.

In the paper feeding device 10, there is a certain degree of freedom in the axial direction (sheet width direction) of the roll’s mounting position. Therefore, when the roll in the paper feeding device 10 is replaced, the skew of the sheet S becomes significant. The user pulls out the leading edge of the sheet from the replaced roll and brings it to the position of the splicing unit 11. Subsequently, the user lowers the sheet pressing mechanism 26 to press the sheet S and connects the leading edge of the pulled-out sheet S with the trailing edge of the cut sheet S remaining in the recording apparatus 1 using a splicing tape. Then, the user raises the two sheet pressing mechanisms 26 to complete the roll replacement operation.

As described above, when replacing the roll, the user raises and lowers the sheet pressing mechanism 26. Therefore, whether a predetermined condition causing a significant skew of the sheet S has occurred can be determined based on whether the sheet pressing mechanism 26 has been operated. In the recording apparatus 1 of the first embodiment, when at least one of the lowering or raising of the sheet pressing mechanism 26 is detected, it is determined that the roll in the paper feeding device 10 has been replaced. Additionally, the recording apparatus 1 determines that the roll in the paper feeding device 10 has been replaced when at least one of the lowering or raising is detected in at least one of the sheet pressing mechanism 26 upstream of the splicing unit 11 or the sheet pressing mechanism 26 downstream of the splicing unit 11.

The method for determining that the roll in the paper feeding device 10 has been replaced is not limited to this. For example, the operation of the sheet pressing mechanism 26 for determining that the roll in the paper feeding device 10 has been replaced may be limited to either the raising or the lowering direction. Additionally, the sheet pressing mechanism 26 to be monitored for detecting the operation to determine that the roll in the paper feeding device 10 has been replaced may be limited to the sheet pressing mechanism 26 upstream or downstream of the splicing unit 11.

Depending on the type of splicing tape or the way it is applied, the spliced portion may become thicker, potentially causing the spliced portion to contact the heads of the recording unit 13. Additionally, when the spliced portion passes through the roller pairs of the main conveyance unit 12 and the sub-conveyance unit 15, variations in sheet conveyance may occur. Therefore, after replacing the roll in the paper feeding device 10, the sheet is conveyed until the spliced portion is positioned downstream of the sub-conveyance unit 15. After replacing the roll in the paper feeding device 10, the user operates the sheet feeding operating unit 5 to manually perform the feeding operation until the spliced portion is positioned downstream of the sub-conveyance unit 15. Once the spliced portion has passed downstream of the sub-conveyance unit 15, the roll replacement operation is considered complete.

When connecting the trailing edge and the leading edge of the sheet with a splicing tape, the main conveyance unit 12 and the sub-conveyance unit 15 may be in the nip state. However, when feeding a new sheet or performing jam handling, it is difficult for the user to insert the sheet through the main conveyance unit 12 and the sub-conveyance unit 15 in the nip state. Additionally, if the roller pair is rotated to pass the sheet while in the nip state, there is a risk that the user’s fingers may be caught in the nip portion. Therefore, when feeding a new recording medium or performing jam handling, the main conveyance unit 12 and the sub-conveyance unit 15 are set to the nip release state. This makes it easier to pass the sheet through the main conveyance unit 12 and the sub-conveyance unit 15. However, when the main conveyance unit 12 and the sub-conveyance unit 15 are in the nip release state, the sheet is not held, which may cause the sheet’s position to shift. Therefore, the recording apparatus 1 determines that a condition causing a significant skew of the sheet has occurred when at least one of the main conveyance unit 12 or the sub-conveyance unit 15 is in the nip release state.

When removing a finished product from the take-up device 17 after recording is completed, the sheet pressing mechanism 27 is lowered to bring the sheet into a non-moving state. In this state, the user cuts the sheet using a cutting unit 16 to remove the finished product. Subsequently, the user attaches a core (paper tube) to the take-up device 17 and affixes the leading edge of the sheet remaining in the recording apparatus 1 after cutting the finished product to the core of the take-up device 17 with a tape or the like. Then, the user raises the sheet pressing mechanism 27 by operating the pressing mechanism operating unit. In this way, the removal operation of the finished product is completed. The recording apparatus 1 determines whether the finished product has been removed from the take-up device 17 based on whether the sheet pressing mechanism 27 has been operated, similar to how roll replacement in the paper feeding device 10 is determined.

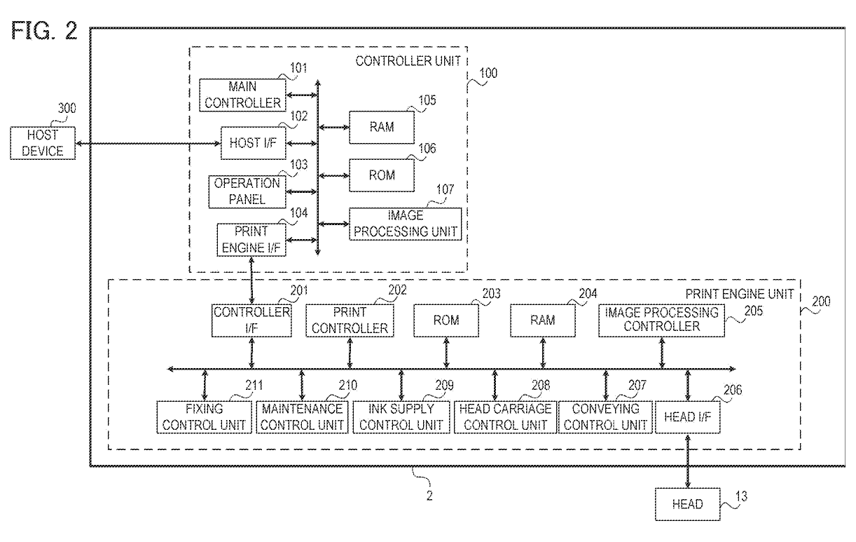

FIG. 2 is a block diagram showing a functional configuration of the control unit 2 of the recording apparatus 1. The control unit 2 includes a print engine unit 200 that primarily controls a print engine and a controller unit 100 that controls the entire recording apparatus 1. A print controller 202 of the print engine unit 200 controls various control units of the print engine unit 200 in accordance with instructions from a main controller 101 of the controller unit 100.

In the controller unit 100, the main controller 101, constituted by a CPU, controls the entire recording apparatus 1 using a RAM 105 as a work area in accordance with programs and various parameters stored in a ROM 106. For example, when a recording job is input from a host device 300 via a host I/F 102, the main controller 101 recognizes the recording job and displays the input job on an operation panel 103. When the main controller 101 detects that a recording execution button on the operation panel 103 is pressed, an image processing unit 107 performs predetermined image processing on the image data of the job in the input order. Then, the main controller 101 sends the processed image data to the print engine unit 200 via a print engine I/F 104.

The recording apparatus 1 may acquire image data from a connected external storage device (such as a USB memory). The operation panel 103 is an operation unit that allows the user to input instructions to the recording apparatus 1 and displays information to be presented to the user. The user can instruct recording execution or sheet feeding operations, set a recording mode, or check information about the recording apparatus 1 via the operation panel 103. The operation panel 103 includes a touch panel or buttons. In addition to or in place of the operation panel 103, a mouse or keyboard may be connected to the recording apparatus 1 to allow the user to input instructions.

In the print engine unit 200, the print controller 202, constituted by a CPU, controls the operations of each component of the recording apparatus 1 using a RAM 204 as a work area in accordance with programs and various parameters stored in a ROM 203. When various commands and image data are received via a controller I/F 201, the print controller 202 temporarily stores them in the RAM 204. To enable the recording unit 13 to use the data in recording operations, the print controller 202 causes an image processing controller 205 to convert the stored image data into recording data. Once the recording data is generated, the print controller 202 causes the recording unit 13 to perform a recording operation based on the recording data via a head I/F 206.

During the recording operation, the print controller 202 drives the paper feeding device 10, the main conveyance unit 12, the sub-conveyance unit 15, the take-up device 17, the skew correction unit 20, and the tension detector 6 via a conveying control unit 207 to perform a feeding operation to convey the sheet in the forward direction or a rewinding operation to convey the sheet in the reverse direction.

The print controller 202 detects via the conveying control unit 207 whether the main conveyance unit 12 and the sub-conveyance unit 15 are in the nip state or the nip release state and performs control to transition to the nip state or the nip release state. For example, the print controller 202 controls the main conveyance unit 12 and the sub-conveyance unit 15 to be in the nip release state during jam handling.

When the user inputs an instruction to operate the sheet pressing mechanism 26 via the sheet pressing operating unit, the print controller 202 detects the operation of the sheet pressing operating unit via the conveying control unit 207 and detects the instruction input for raising or lowering the sheet pressing mechanism 26. When the sheet feeding operating unit 5, described later with reference to FIG. 5, is operated, the print controller 202 detects the operation of the sheet feeding operating unit 5. Upon detecting an operation of the sheet feeding operating unit 5, the print controller 202 fixes the rotation shaft 22 of the skew correction unit 20 only when an instruction for a rewinding operation is input. While the sheet feeding operating unit 5 is being operated, the print controller 202 drives the paper feeding device 10, the main conveyance unit 12, the sub-conveyance unit 15, and the take-up device 17 via the conveying control unit 207 at a specified speed described later. As a result, the sheet is conveyed in the forward or reverse direction.

The print controller 202 controls the conveyance amount of the sheet via the conveying control unit 207 based on the rotation amount of an encoder (not shown) attached to the roller. When performing conveyance of a first conveyance amount or a second conveyance amount described later, the print controller 202 detects, via the conveying control unit 207, that the encoder value has advanced by an amount of change corresponding to the target conveyance amount from the encoder value at the start of driving and determines that the conveyance is completed.

The print controller 202 drives the heater and fan of the dryer and the fan of the cooler in the fixing unit 14 via a fixing control unit 211. In accordance with instructions from the print controller 202, the recording operation by the recording unit 13 is performed in coordination with the sheet conveyance direction, and recording is performed.

The heads of the recording unit 13 are movable vertically, and a head carriage control unit 208 changes the vertical position of the heads of the recording unit 13 depending on the operation state, such as maintenance operations or recording operations of the recording apparatus 1. The head carriage control unit 208 lowers the heads of the recording unit 13 during recording operations. On the other hand, when the maintenance of the head is performed, the head carriage control unit 208 raises the heads.

An ink supply control unit 209 controls an ink supply unit so that the pressure of ink supplied to the heads of the recording unit 13 is within an appropriate range. A maintenance control unit 210 moves a maintenance unit under the raised heads during maintenance operations for color heads or white heads and controls head maintenance operations such as capping or wiping.

The configuration of the skew correction unit 20 in the first embodiment will be described with reference to FIGS. 3A and 3B. FIG. 3A is a cross-sectional view of the skew correction unit 20 viewed from the sheet width direction. FIG. 3B is a top view of the skew correction unit 20. The skew correction unit 20 is a position adjustment unit that adjusts the widthwise position of the sheet. By providing the skew correction unit 20 between the main conveyance unit 12 and the recording unit 13, the widthwise position of the sheet can be adjusted before recording by the recording unit 13, reducing the skew of the sheet.

The skew correction unit 20 includes a holding frame 30 that holds two skew correction rollers 31, a sensor 21 that detects the position of the widthwise edge portion of the sheet, and a rotation shaft 22 that rotatably supports the holding frame 30. The skew correction unit 20 adjusts the widthwise position of the sheet while conveying the sheet in the forward direction with the skew correction rollers 31, and corrects the positional deviation from the target position. The holding frame 30 is rotatable by driving a motor (not shown) around a rotation shaft orthogonal to the rotation shaft direction of the skew correction rollers 31. Additionally, the holding frame 30 can fix the rotation shaft 22 so as not to rotate by exciting a motor (not shown). By rotating the holding frame 30 to tilt relative to the sheet conveyance direction while the skew correction rollers 31 convey the sheet, the widthwise position of the sheet is adjusted. The skew correction unit 20 can sequentially adjust the widthwise position of the sheet by rotating the holding frame 30 while detecting the widthwise position of the sheet with the sensor 21.

The sensor 21 is preferably disposed downstream in the forward direction of the skew correction unit 20. In the first embodiment, the sensor 21 is provided between the skew correction roller 31 located downstream in the forward direction among the two skew correction rollers 31 and a driven roller 32 located downstream in the forward direction relative to that skew correction roller 31. In the skew correction unit 20, when the sensor 21 detects the position of the widthwise edge portion of the sheet, the phase of the holding frame 30 is changed so that the position of the widthwise edge portion of the sheet aligns with the target position. When the sheet is conveyed with the holding frame 30 rotated, the sheet becomes twisted between the skew correction roller 31 and the driven roller 32, and the position of the widthwise edge portion of the sheet is gradually adjusted to the target position.

It is desirable that the mounting positions of the rolls in the paper feeding device 10 and the take-up device 17 in the width direction (vertical direction in the figure) are at the same central position in the width direction. However, there is a certain degree of freedom in the mounting positions of the rolls in the paper feeding device 10 and the take-up device 17 in the width direction. Therefore, as shown in FIG. 3B, the mounting position of the roll in the paper feeding device 10 may be misaligned with the mounting position of the roll in the take-up device 17. Even in such a state, by conveying the sheet in the forward direction by a certain conveyance amount or more, the sheet conveyance is stabilized.

FIG. 3C illustrates a state where, with the sheet conveyance stabilized in the state of FIG. 3B, the roll in the paper feeding device 10 is replaced, and the mounting position of the replaced roll is shifted toward the back side in the width direction (upper side in the figure) relative to FIG. 3B. When a feeding operation is performed to convey the sheet in the forward direction in the state of FIG. 3C, the widthwise edge portion of the sheet gradually shifts toward the back side in the width direction, and the position of the widthwise edge portion of the sheet detected by the sensor 21 moves toward the back side in the width direction.

Ultimately, as shown in FIG. 3D, the holding frame 30 rotates to an angle at which the sheet is conveyed linearly from the paper feeding device 10 to the take-up device 17, and the rotation of the holding frame 30 converges. When the roll in the take-up device 17 is replaced and the mounting position in the width direction changes, the skew is corrected by the same operation.

In this manner, the control unit 2 of the recording apparatus 1 performs skew correction control to correct the skew of the sheet by performing a feeding operation (forward conveyance direction) of a predetermined conveyance amount with the conveyance units (main conveyance unit 12 and sub-conveyance unit 15) while performing a correction operation with the skew correction unit 20.

As shown in FIG. 3C, when a roll is replaced in the paper feeding device 10 or the take-up device 17, a significant skew of the sheet may occur. In the first embodiment, the recording apparatus 1 determines that a predetermined condition causing a significant skew of the sheet has occurred when a roll is replaced in the paper feeding device 10 or the take-up device 17.

Here, since the sensor 21 is provided downstream in the forward direction of the skew correction unit 20, the skew correction unit 20 does not perform a correction operation for correcting the skew of the sheet during a rewinding operation. Therefore, the control unit 2 executes skew correction control before starting a rewinding operation. That is, a rewinding operation is performed after performing a feeding operation in the forward direction with a predetermined conveyance amount while performing a correction operation with the skew correction unit. During this rewinding operation, the skew correction unit 20 fixes the rotation shaft by exciting a motor (not shown) to prevent the holding frame 30 from rotating and stops the correction operation.

Since the skew correction unit 20 does not perform a correction operation during a rewinding operation, a positional deviation of the edge portion of the recording medium occurs. Therefore, the recording apparatus 1 determines that a predetermined condition causing a significant skew of the sheet has occurred when a rewinding operation is performed.

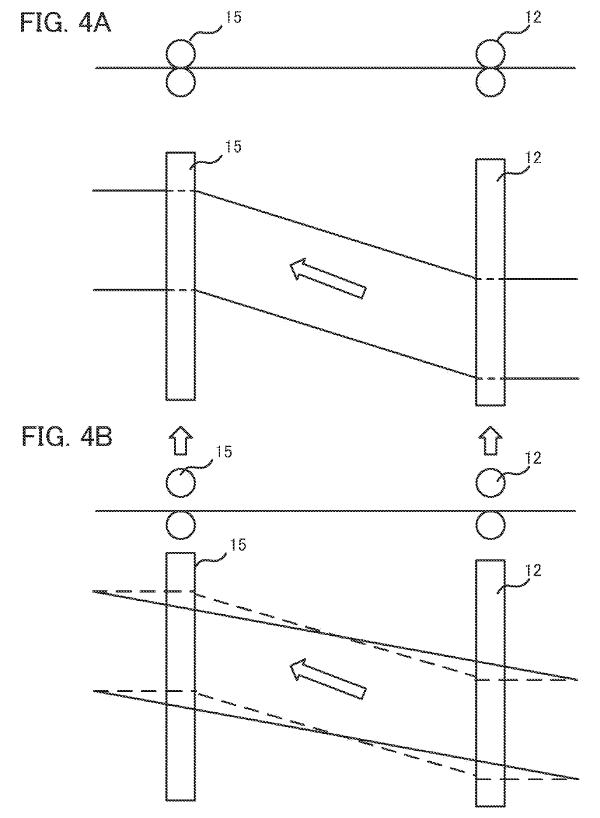

FIGS. 4A and 4B are diagrams showing the sheet conveyance state in the first embodiment when the main conveyance unit 12 and the sub-conveyance unit 15 are changed from the nip state to the nip release state.

FIG. 4A is a diagram showing a case where the main conveyance unit 12 and the sub-conveyance unit 15 are in the nip state, in which the upper figure is a side view seen from the width direction and the lower figure is a top view seen from above. FIG. 4B is a diagram showing a case where the main conveyance unit 12 and the sub-conveyance unit 15 are changed from the nip state to the nip release state in FIG. 4A, in which the upper figure is a side view seen from the width direction and the lower figure is a top view seen from above. In FIG. 4B, the sheet position in FIG. 4A is indicated by dashed lines.

In FIG. 4A, although the roll in the paper feeding device 10 is mounted on the front side in the width direction (lower side in the figure) and the roll in the take-up device 17 is mounted on the back side in the width direction (upper side in the figure), the sheet is conveyed stably after being conveyed by a sufficient amount in the forward direction 18.

As shown in FIG. 4B, when the nip is released from the state of FIG. 4A, the sheet held by the main conveyance unit 12 and the sub-conveyance unit 15 is released, resulting in a state in which the sheet is conveyed in a nearly linear form. However, since the actual conveyance path in the recording apparatus 1 has a complex shape, the sheet conveyance state when the nip is released may not be as simple as shown in FIG. 4B.

When the main conveyance unit 12 and the sub-conveyance unit 15 are returned to the nip state and the sheet is conveyed from the state of FIG. 4B, the position of the widthwise edge portion of the sheet may deviate from the stable position in FIG. 4B, potentially causing a significant skew. Therefore, in the first embodiment, the recording apparatus 1 determines that a predetermined condition causing a significant skew of the sheet has occurred when the nip portion is released in at least one of the main conveyance unit 12 or the sub-conveyance unit 15.

The control unit 2 executes a first control to correct the skew of the sheet with a first conveyance amount as the conveyance amount of the sheet after a predetermined condition causing a skew of the sheet has occurred. Additionally, the control unit 2 executes a second control to correct the skew of the sheet with a second conveyance amount, which is less than the first conveyance amount, as the conveyance amount of the sheet when the predetermined condition has not occurred. The second conveyance amount may be 0 meters, i.e., no conveyance.

The control unit 2 determines that a predetermined condition causing a skew of the sheet has occurred in the following cases: when the nip portion of the roller pair is released in at least one of the main conveyance unit 12 or the sub-conveyance unit 15, when a roll is replaced in at least one of the paper feeding device 10 or the take-up device 17, or when a rewinding operation is performed. The control unit 2 determines that a roll has been replaced in the paper feeding device 10 when an operation to raise or lower the sheet pressing mechanism 26 is performed. Additionally, the control unit 2 determines that a roll has been replaced in the take-up device 17 when an operation to raise or lower the sheet pressing mechanism 27 is performed.

The control unit 2 executes skew correction control before starting a recording operation by the recording unit 13 or before starting a rewinding operation by the conveyance units (main conveyance unit 12 and sub-conveyance unit 15).

That is, when an instruction to execute a recording operation is received, the control unit 2 first executes skew correction control and then executes the recording operation after the skew correction control is completed. When the instruction to execute the recording operation is received, if it is determined that a predetermined condition causing a skew of the sheet has occurred (when a significant skew flag is ON, as described later), the control unit 2 executes skew correction control with the first conveyance amount. In other cases (when the significant skew flag is OFF), the control unit 2 executes skew correction control with the second conveyance amount. The control unit 2 executes the recording operation after the skew correction control with the first conveyance amount or the second conveyance amount is completed.

Additionally, when an instruction to execute a rewinding operation is received, the control unit 2 first executes skew correction control and then executes the rewinding operation after the skew correction control is completed. In this case, since the rewinding operation is performed with the sheet conveyance stabilized, the control unit 2 fixes the rotation shaft 22 of the skew correction unit 20 and stops the correction operation during the execution of the rewinding operation. When the instruction to execute the rewinding operation is received, if it is determined that a predetermined condition causing a skew of the sheet has occurred (when the significant skew flag is ON), the control unit 2 executes skew correction control with the first conveyance amount. In other cases (when the significant skew flag is OFF), the control unit 2 executes skew correction control with the second conveyance amount. The control unit 2 executes the rewinding operation after the skew correction control with the first conveyance amount or the second conveyance amount is completed.

FIG. 5 is a diagram showing the sheet feeding operating unit 5. The sheet feeding operating unit 5 includes a low-speed feed button 500, a high-speed feed button 501, and a low-speed rewind button 502. By pressing these buttons, the user can manually perform a feeding operation or a rewinding operation with an arbitrary conveyance amount.

When the print controller 202 detects that the low-speed feed button 500 is pressed, it performs a feeding operation to convey the sheet in the forward direction 18 at 4.5 meters per minute (mpm). When the print controller 202 detects that the high-speed feed button 501 is pressed, it performs a feeding operation to convey the sheet in the forward direction 18 at 20 mpm. When the print controller 202 detects that the low-speed rewind button 502 is pressed, it fixes the rotation shaft 22 so that the holding frame 30 of the skew correction unit 20 does not rotate and then performs a rewinding operation to convey the sheet in the reverse direction at 4.5 mpm.

When it is determined that a predetermined condition causing a significant skew has occurred and it is detected that the low-speed rewind button 502 is pressed, the print controller 202 may first execute skew correction control with the first conveyance amount and then execute the rewinding operation. In this case, after executing the skew correction control with the first conveyance amount, the rotation shaft 22 is fixed so that the holding frame 30 of the skew correction unit 20 does not rotate, and the sheet is conveyed in the reverse direction at 4.5 mpm. However, if such control is performed, the user may feel a sense of discomfort because, despite pressing the rewind button, the sheet is first conveyed in the opposite forward direction 18. Therefore, the control unit 2 may be configured not to execute skew correction control before starting a rewinding operation in response to the user operation of the low-speed rewind button 502. That is, when the low-speed rewind button 502 is operated, the control unit 2 immediately fixes the rotation shaft 22 of the skew correction unit 20 and executes the rewinding operation without performing a feeding operation in the forward direction 18.

At this time, the control unit 2 may vary the upper limit of the conveyance amount by the manual rewinding operation depending on whether it is determined that a predetermined condition causing a significant skew has occurred before execution of the rewinding operation in response to the user operation of the low-speed rewind button 502. For example, when it is determined that the predetermined condition has occurred at the time of detecting the pressing of the low-speed rewind button 502, the upper limit of the conveyance amount by the manual rewinding operation is set to 5 meters. When it is not determined that the predetermined condition has occurred, the upper limit of the conveyance amount by the manual rewinding operation is set to 30 meters. By varying the upper limit of the conveyance amount by the manual rewinding operation depending on the occurrence of the predetermined condition, issues such as a significant skew of the sheet and the sheet’s edge portion detaching from the skew correction unit 20 can be suppressed. The values of the upper limit of the conveyance amount by the manual rewinding operation are examples and are appropriately determined according to the specific configuration of the recording apparatus 1. Additionally, when it is not determined that the predetermined condition has occurred, i.e., when the sheet conveyance is stable, the upper limit of the conveyance amount by the manual rewinding operation may not be set.

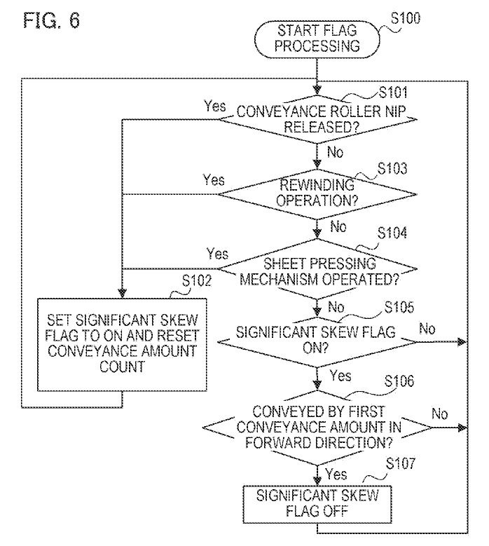

FIG. 6 is a flowchart showing a process of setting a flag for skew correction control. When the recording apparatus 1 is started, the print controller 202 starts flag processing at step S100, and the processing continues until the power of the recording apparatus 1 is turned off.

At step S101, the print controller 202 determines whether the nip portion of the roller pair has been released in at least one of the main conveyance unit 12 or the sub-conveyance unit 15. The print controller 202 executes the processing of step S102 each time a nip release is detected. If a nip release is not detected, the print controller 202 executes step S103.

At step S102, the print controller 202 sets a significant skew flag ON to indicate that a predetermined condition causing a significant skew of the sheet has occurred. At this time, the print controller 202 resets the count of the conveyance amount referenced in step S106 described later.

At step S103, the print controller 202 determines whether a rewinding operation has been executed. The print controller 202 executes the processing of step S102 each time the execution of a rewinding operation is detected. If the execution of a rewinding operation is not detected, the print controller 202 executes step S104.

At step S104, the print controller 202 determines whether the sheet pressing mechanism 26 or the sheet pressing mechanism 27 has been operated. This is a process to determine whether a roll has been replaced in the paper feeding device 10 or the take-up device 17. The print controller 202 executes the processing of step S102 each time it detects that a raising or lowering operation has been performed in the sheet pressing mechanism 26 or the sheet pressing mechanism 27. If no operation of the sheet pressing mechanism 26 or the sheet pressing mechanism 27 is detected, the print controller 202 executes step S105.

At step S105, the print controller 202 checks whether the significant skew flag is ON, and if it is not ON, returns to step S101 to repeat the processing. If the significant skew flag is ON at step S105, the print controller 202 executes step S106.

At step S106, the print controller 202 determines whether the conveyance amount of the sheet in the forward direction 18 after the significant skew flag was set to ON has reached or exceeded the first conveyance amount. The first conveyance amount is a conveyance amount at which it can be determined that the sheet conveyance has stabilized (the widthwise position has converged to a stable position) after a significant skew occurs, such as the significant skew flag being set to ON. If the conveyance amount of the sheet in the forward direction 18 after the significant skew flag was set to ON has reached or exceeded the first conveyance amount, the print controller 202 executes step S107.

At step S107, the print controller 202 sets the significant skew flag to OFF and returns to step S101 to repeat the processing.

At step S106, if the conveyance amount of the sheet in the forward direction 18, after the significant skew flag was set to ON, has not reached the first conveyance amount, since the sheet conveyance is not stable, the print controller 202 returns to step S101 to repeat the processing.

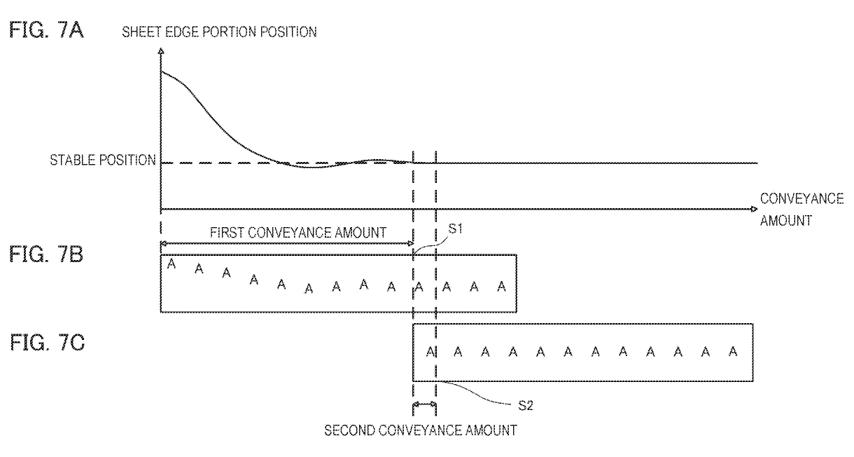

FIG. 7A is a diagram showing the relationship between the position of the widthwise edge portion of the sheet and the conveyance amount when a predetermined condition causing a significant skew of the sheet occurs (when the significant skew flag is ON). The vertical axis of FIG. 7A represents the position of the widthwise edge portion of the sheet, and the horizontal axis represents the conveyance amount of the sheet immediately after the predetermined condition occurred. The graph is an example.

The position of the widthwise edge portion of the sheet converges toward a stable position as the sheet is conveyed in the forward direction from the state immediately after the predetermined condition occurs (immediately after the significant skew flag is set to ON). The first conveyance amount in the skew correction control is set as a length at which it can be determined that the position of the widthwise edge portion of the sheet has converged to a stable position after a significant variation due to the occurrence of the predetermined condition.

FIG. 7B is a top view schematically showing a recorded image when a recording operation is performed in a state in which the sheet is not conveyed in the forward direction after a predetermined condition causing a significant skew of the sheet occurs (after the significant skew flag is set to ON). The recorded image is an image with the letter “A” arranged at the center in the width direction of the sheet. When a predetermined condition causing a significant skew of the sheet occurs, the widthwise position of the sheet does not stabilize until the sheet is conveyed in the forward direction by the first conveyance amount or more. Therefore, the position in the sheet width direction of the image actually recorded on the sheet is not stable and significantly deviates from the center in the width direction. When the conveyance amount of the sheet in the forward direction exceeds the first conveyance amount, the widthwise position of the sheet stabilizes, and the position of the image actually recorded on the sheet does not significantly deviate from the center in the width direction.

In the recording apparatus 1 of the first embodiment, when the significant skew flag is ON and an instruction to execute a recording operation is received, the recording operation is not executed until the sheet is conveyed in the forward direction by the first conveyance amount or more. Then, the recording operation is executed after executing skew correction control to convey the sheet in the forward direction by the first conveyance amount or more. Therefore, the actual printing start position is the position S1 in FIG. 7B.

FIG. 7C is a top view schematically showing a recorded image when a recording operation is performed in a state in which the sheet is not conveyed in the forward direction when a predetermined condition causing a significant skew of the sheet has not occurred (when the significant skew flag is OFF). The recorded image is the same as that in FIG. 7B. In this case, the widthwise position of the sheet is stable. Therefore, in the recording apparatus 1 of the first embodiment, when the significant skew flag is OFF and an instruction to execute a recording operation is received, skew correction control is executed to convey the sheet in the forward direction by the second conveyance amount, which is less than the first conveyance amount, and then the recording operation is executed. Therefore, the actual printing start position is the position S2 in FIG. 7C.

The graph shown in FIG. 7A illustrates the relationship between the conveyance amount and the convergence of the widthwise position of the sheet when the sheet tension is the same as that during recording operations. However, the conveying control unit 207 may control the conveyance tension during the execution of skew correction control to be greater than the tension during recording operations. In this way, the conveyance amount in the forward direction required for the sheet’s widthwise position to stabilize can be reduced. That is, the first conveyance amount in the skew correction control can be reduced. In this way, waste paper can be reduced and the waiting time until printing starts can be shortened.

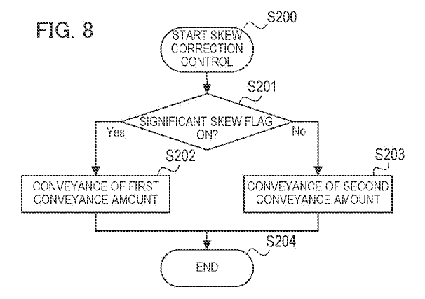

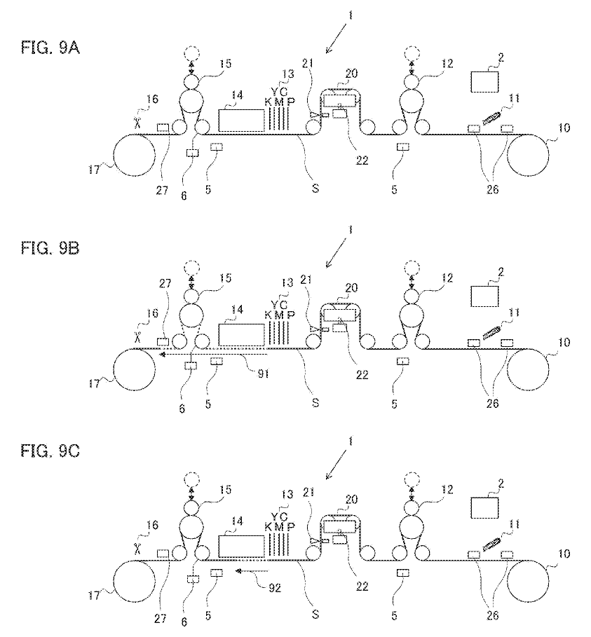

FIG. 8 is a flowchart showing skew correction control. FIGS. 9A to 9C are diagrams showing the state of the recording apparatus 1 during the execution of skew correction control. FIG. 9A illustrates a state in which the recording apparatus 1 is stopped, similar to FIG. 1. In the state of FIG. 9A, when an instruction for a recording operation or a rewinding operation is received, the print controller 202 starts skew correction control at step S200.

At step S201, the print controller 202 checks the significant skew flag, executes step S202 if the significant skew flag is ON, and executes step S203 if the significant skew flag is OFF.

At step S202, the print controller 202 executes skew correction control to perform a feeding operation of the sheet in the forward direction with the first conveyance amount while performing a correction operation with the skew correction unit 20.

For example, during the execution of a recording operation, with the first conveyance amount set to 10 meters, the sheet is conveyed 10 meters in the forward direction, and then the recording operation (ejection) is started. FIG. 9B illustrates a state in which the sheet is conveyed by the first conveyance amount, as indicated by arrow 91, from the state of FIG. 9A, and ejection is enabled. The first conveyance amount is the same value as the first conveyance amount shown in FIGS. 7A to 7C. The sheet of the first conveyance amount is indicated by dashed lines in FIG. 9B. At the point when ejection is started by the recording unit 13 after executing skew correction control with the first conveyance amount, the skew of the sheet is stabilized, and the widthwise position is constant, as shown in FIGS. 7A to 7C.

The print controller 202 detects, via the conveying control unit 207, that the encoder value has advanced by an amount corresponding to the first conveyance amount from the encoder value at the start of conveyance by skew correction control, and then starts the recording operation.

Here, it is assumed that the sheet has been conveyed by a third conveyance amount in the forward direction from immediately after a predetermined condition causing a significant skew has occurred (immediately after the significant skew flag is set to ON) until an instruction to execute a recording operation is received. In this case, the conveyance amount in the forward direction in the skew correction control after receiving the instruction to execute the recording operation may be a value obtained by subtracting the third conveyance amount from the first conveyance amount. For example, if an instruction to execute a recording operation is received after the sheet is conveyed 6 meters in the forward direction from immediately after the significant skew flag is set to ON, the conveyance amount in the forward direction in the subsequent skew correction control is set to 4 meters. That is, after the sheet is conveyed 4 meters in the forward direction, the recording operation (ejection) is started. In this way, the conveyance amount in the skew correction control can be reduced.

However, since actual ejection may not be executable until other conditions are met, the ejection start timing is determined considering those conditions as well. For example, even if the sheet is conveyed 4 meters, if the drying temperature of the dryer in the fixing unit 14 has not reached the target temperature, ejection will be started after the target temperature is reached. If the drying temperature is already close to the target temperature, such as immediately after the previous recording operation, the print controller 202 may start ejection when the sheet is conveyed by the necessary conveyance amount in the skew correction control before the recording operation is performed.

During the execution of a rewinding operation, similarly, with the first conveyance amount set to 10 meters, if an instruction to execute a rewinding operation is received immediately after a predetermined condition causing a significant skew has occurred, skew correction control is executed to convey the sheet 10 meters in the forward direction, and then the rewinding operation is executed. At this time, the rewinding operation is executed with the rotation shaft 22 fixed so that the holding frame 30 of the skew correction unit 20 does not rotate. When the sheet is conveyed 10 meters in the forward direction by skew correction control, the state shown in FIG. 9B is achieved. From the state of FIG. 9B, the rewinding operation is executed with the rotation shaft 22 fixed so that the holding frame 30 of the skew correction unit 20 does not rotate.

At step S203, the print controller 202 executes skew correction control to perform a feeding operation of the sheet in the forward direction with the second conveyance amount while performing a correction operation with the skew correction unit 20.

For example, during the execution of a recording operation, with the second conveyance amount set to 2 meters, the sheet is conveyed 2 meters in the forward direction, and then the recording operation (ejection) is started. FIG. 9C illustrates a state in which the sheet is conveyed by the second conveyance amount, as indicated by arrow 92, from the state of FIG. 9A, and ejection is enabled. The second conveyance amount is the same value as the second conveyance amount shown in FIGS. 7A to 7C. The sheet of the second conveyance amount is indicated by dashed lines in FIG. 9C. At the point when ejection is started by the recording unit 13 after executing skew correction control with the second conveyance amount, the skew of the sheet is stabilized, and the widthwise position is constant, as shown in FIGS. 7A to 7C.

During the execution of a rewinding operation, similarly, with the second conveyance amount set to 2 meters, the sheet is conveyed 2 meters in the forward direction, and then the rewinding operation is executed with the rotation shaft 22 fixed so that the holding frame 30 of the skew correction unit 20 does not rotate. When the sheet is conveyed 2 meters in the forward direction by skew correction control, the state shown in FIG. 9C is achieved. From the state of FIG. 9C, the rewinding operation is executed with the rotation shaft 22 fixed so that the holding frame 30 of the skew correction unit 20 does not rotate.

As described above, in the recording apparatus 1 of the first embodiment, before executing a recording operation or a rewinding operation after a predetermined condition causing a significant skew has occurred, such as nip release of the conveyance unit, roll replacement, or execution of a rewinding operation, skew correction control is performed with the first conveyance amount. In other cases, before executing a recording operation or a rewinding operation, skew correction control is performed with the second conveyance amount, which is less than the first conveyance amount. In this way, the impact of skew can be reduced when a significant skew occurs, and when significant skew does not occur, the conveyance amount in the skew correction control is reduced, thereby reducing the amount of waste paper and the waiting time due to skew correction control. Thus, the technology described in this specification can contribute to the realization of a sustainable society, such as a decarbonized/circular society.

According to the present disclosure, the skew of the sheet can be suppressed in a recording apparatus that records images on a continuous sheet.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-174562, filed on October 3, 2024, which is hereby incorporated by reference herein in its entirety.

What is claimed is:

1. A recording apparatus comprising:
a recording unit configure to record images on a continuous sheet;
a conveyance unit configured to convey the sheet in a forward direction, which is a conveyance direction during recording by the recording unit, and in a reverse direction opposite to the forward direction;
a correction unit configured to correct a skew of the sheet; and
a control unit configured to control the correction unit and the conveyance unit while correcting the skew of the sheet conveyed in the forward direction,
wherein the control unit executes a first control and a second control, the first control being a control to correct the skew of the sheet with a first conveyance amount as a conveyance amount of the sheet after a predetermined condition causing a skew of the sheet has occurred, and the second control being a control to correct the skew of the sheet with a second conveyance amount, which is less than the first conveyance amount, when the predetermined condition has not occurred.

2. The recording apparatus according to claim 1,
wherein in the first control, the recording unit starts recording once the sheet has been conveyed by the first conveyance amount, and in the second control, the recording unit starts recording after the sheet is conveyed by the second conveyance amount.

3. The recording apparatus according to claim 1,
wherein the conveyance unit includes a roller pair forming a nip portion that holds the sheet, and
wherein the control unit determines that the predetermined condition has occurred when the nip portion of the roller pair is released.

4. The recording apparatus according to claim 1, further comprising
an unwinding unit configured to supply the sheet to the recording unit from a roll in which the sheet is wound around a core,
wherein the control unit determines that the predetermined condition has occurred when the roll in the unwinding unit is replaced.

5. The recording apparatus according to claim 1, further comprising
a take-up unit configured to wind the sheet that has passed through the recording unit onto a roll in which the sheet is wound around a core, and
wherein the control unit determines that the predetermined condition has occurred when the roll in the take-up unit is replaced.

6. The recording apparatus according to claim 1,
wherein the control unit determines that the predetermined condition has occurred when the sheet is conveyed in the reverse direction by the conveyance unit.

7. The recording apparatus according to claim 1,
wherein the control unit corrects the skew of the sheet by the correction unit before the conveyance unit conveys the sheet in the reverse direction.

8. The recording apparatus according to claim 7,
wherein, when the conveyance unit conveys the sheet in the reverse direction after correcting the skew of the sheet by the correction unit, the control unit stops the correction of the skew of the sheet by the correction unit.

9. The recording apparatus according to claim 7, further comprising
an operation unit that allows a user operation to cause the conveyance unit to perform conveyance in the forward direction or the reverse direction with an arbitrary conveyance amount,
wherein the control unit does not execute correction of the skew of the sheet by the correction unit before starting conveyance in the reverse direction by the conveyance unit in response to the user operation.

10. The recording apparatus according to claim 9,
wherein the conveyance unit varies an upper limit of the conveyance amount by conveyance in the reverse direction depending on whether the predetermined condition has occurred before the conveyance in the reverse direction in response to the user operation.

11. The recording apparatus according to claim 1, further comprising
a conveying control unit configured to control tension applied to the sheet,
wherein the conveying control unit sets the conveyance tension during correction of the skew of the sheet by the correction unit to be greater than the tension during recording by the recording unit.

12. A control method of a recording apparatus,
the recording apparatus comprising:
a recording unit configured to record images on a continuous sheet;
an unwinding unit configured to supply the sheet to the recording unit from a roll in which the sheet is wound around a core;
a take-up unit configured to wind the sheet that has passed through the recording unit onto a roll in which the sheet is wound around a core;
a conveyance unit configured to convey the sheet in a forward direction, which is a conveyance direction during recording by the recording unit, and in a reverse direction opposite to the forward direction; and
a correction unit configured to correct a skew of the sheet,
the control method of the recording apparatus comprising:
determining whether a predetermined condition causing a skew of the sheet has occurred;
correcting the skew of the sheet with a first conveyance amount as a conveyance amount of the sheet after the predetermined condition has occurred; and
correcting the skew of the sheet with a second conveyance amount, which is less than the first conveyance amount, when the predetermined condition has not occurred.
